(19) United States
(12) Patent Application Publication
(10) Pub. No.: US 2026/0237633 A1
(43) Pub. Date: Aug. 13, 2026

(54) RECHARGEABLE LITHIUM BATTERIES

(71) Applicant: SAMSUNG SDI CO., LTD., Yongin-si (KR)

(72) Inventors: Sungjin SEO, Yongin-si (KR); Dannbee KIM, Yongin-si (KR)

(73) Assignee: SAMSUNG SDI CO., LTD., Yongin-si (KR)

(21) Appl. No.: 19/531,341

(22) Filed: Feb. 5, 2026

(30) Foreign Application Priority Data
Feb. 12, 2025 (KR) 10-2025-0018232

(51) Int. Cl. H01M 4/133; H01M 4/02; H01M 4/587; H01M 4/62; H01M 10/052; H01M 10/42

(52) U.S. Cl. CPC H01M 4/133; H01M 4/587; H01M 4/625; H01M 10/052; H01M 2004/027; H01M 2010/4292

(57) ABSTRACT

Disclosed is a rechargeable lithium battery, the rechargeable lithium battery including a positive electrode, a negative electrode, and an electrolyte between the positive electrode and negative electrode. The negative electrode includes a negative electrode current collector and a negative electrode active material layer on the negative electrode current collector. The negative electrode active material layer includes amorphous carbon and a negative electrode active material. In the negative electrode active material layer, from an upper portion farther from the negative electrode collector to a lower portion closer to the negative electrode collector, an amount of the negative electrode active material increases and an amount of the amorphous carbon decreases. The rechargeable lithium battery has a ratio of a discharge capacity per unit area of the negative electrode to the discharge capacity per unit area of the positive electrode of less than or equal to about 1.

### CROSS-REFERENCE TO RELATED APPLICATION

This application claims priority to Korean Patent Application No. 10-2025-0018232 filed with the Korean Intellectual Property Office on Feb. 12, 2025, the entire contents of which are incorporated herein by reference.

### BACKGROUND

### 1. Field

Rechargeable lithium batteries are disclosed.

### 2. Description of the Related Art

A rechargeable lithium battery may be recharged and typically has three or more times as high an energy density per unit weight as a conventional lead storage battery, nickel-cadmium battery, nickel hydrogen battery, nickel zinc battery and the like. A rechargeable lithium battery may be also charged at a high rate, and may thus be commercially manufactured for a laptop, a cell phone, an electric tool, an electric bike, and the like. Improving on additional energy density may be advantageous.

A rechargeable lithium battery is typically manufactured by injecting an electrolyte solution into an electrode assembly, which includes a positive electrode including a positive electrode active material capable of intercalating/deintercalating lithium ions and a negative electrode including a negative electrode active material capable of intercalating/deintercalating lithium ions.

A rechargeable lithium battery that uses an electrolyte solution as described above is called a lithium ion battery, and in a typical lithium ion battery, the battery can be charged within the capacity limit of the negative electrode active material (mainly graphite).

### SUMMARY

Some example embodiments include a rechargeable lithium battery having desired or improved capacity characteristics and fast charging characteristics.

Some example embodiments include a rechargeable lithium battery including a positive electrode, a negative electrode, and an electrolyte between the positive electrode and negative electrode. The negative electrode includes a negative electrode current collector, and a negative electrode active material layer on the negative electrode current collector. The negative electrode active material layer includes amorphous carbon and a negative electrode active material. In the negative electrode active material layer, from an upper portion farther from the negative electrode collector to a lower portion closer to the negative electrode collector, an amount of the negative electrode active material increases and an amount of the amorphous carbon decreases. The rechargeable lithium battery has a ratio (N/P ratio) of a discharge capacity per unit area of the negative electrode to the discharge capacity per unit area of the positive electrode that is less than about 1.

A rechargeable lithium battery according to some example embodiments can exhibit desired or improved capacity characteristics and fast charging characteristics.

### BRIEF DESCRIPTION OF THE DRAWINGS

FIGS. 1 to 4 are schematic views illustrating a rechargeable lithium battery according to some example embodiments.

### DETAILED DESCRIPTION

Hereinafter, example embodiments of the present disclosure are described in detail. However, these embodiments are examples, the present disclosure is not limited thereto, and the present disclosure is defined by the scope of claims.

As used herein, when a specific definition is not otherwise provided, it is understood that when an element such as a layer, film, region, or substrate is referred to as being “on” another element, the element can be directly on the other element, or intervening elements may also be present therebetween.

As used herein, when a specific definition is not otherwise provided, the singular may also include the plural. In addition, unless otherwise specified, “A or B” may mean “including A, including B, or including A and B.”

As used herein, “combination thereof” may mean a mixture, a stack, a composite, a copolymer, an alloy, a blend, or a reaction product of constituents.

As used herein, when a definition is not otherwise provided, a particle diameter may be an average particle diameter. In addition, the particle diameter may refer to an average particle diameter (D50), which means the diameter of particles having a cumulative volume of 50 volume % in the particle size distribution. The average particle diameter (D50) may be measured by a method known to those skilled in the art, for example, by a particle size analyzer, or by a transmission electron microscope image, or a scanning electron microscope image. Alternatively, a dynamic light-scattering measurement device is used to perform a data analysis, and the number of particles is counted for each particle size range. From this, the average particle diameter (D50) value may be readily obtained through a calculation. Alternatively, the average particle diameter (D50) value can be measured using a laser diffraction method. When measuring by the laser diffraction method, for example, the particles to be measured are dispersed in a dispersion medium, and then introduced into a commercially available laser diffraction particle diameter measuring device (e.g., Microtrac MT 3000), and ultrasonic waves of about 28 kHz with an output of 60 W are irradiated to calculate an average particle diameter (D50) on the basis of 50% of the particle diameter distribution in the measuring device.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Rechargeable Lithium Battery:

Some example embodiments include a rechargeable lithium battery including a positive electrode, a negative electrode, and an electrolyte between the positive electrode and negative electrode. The negative electrode includes a negative electrode current collector, and a negative electrode active material layer on the negative electrode current collector. The negative electrode active material layer includes amorphous carbon and a negative electrode active material. In the negative electrode active material layer, from an upper portion farther from the negative electrode collector to a lower portion closer to the negative electrode collector, an amount of the negative electrode active material increases and an amount of the amorphous carbon decreases. The rechargeable lithium battery has a ratio (N/P ratio) of a discharge capacity per unit area of the negative electrode to the discharge capacity per unit area of the positive electrode that is less than about 1.

(1) In a rechargeable lithium battery of some example embodiments, the amount of the negative electrode active material increases while the amount of the amorphous carbon decreases from the upper portion far from the negative electrode current collector to the lower portion close to the negative electrode current collector.

(2) A rechargeable lithium battery of some example embodiments has an N/P ratio that is less than about 1, and lithium ions derived from a lithium salt of the electrolyte solution are deposited in the form of lithium metal on the upper surface of the negative electrode active material layer, so that the battery can be charged beyond the capacity limit of the negative electrode active material.

In this sense, the rechargeable lithium battery of some example embodiments can constitute a ‘hybrid battery of a lithium ion battery and a lithium metal battery.’

Hereinafter, a rechargeable lithium battery according to some example embodiments may be referred to as a ‘hybrid battery’ in some cases.

(3) Furthermore, the amorphous carbon enables high-rate charging of the hybrid battery due to the relatively low density thereof, difference in the charging profile in the low-voltage range, and high specific surface area compared to graphite.

(4) In short, the rechargeable lithium battery of some example embodiments is or includes a hybrid battery designed with an N/P ratio that is less than about 1, which can exhibit desired or improved capacity characteristics, and high-rate charging of the hybrid battery can be possible due to the presence of the amorphous carbon.

Hereinafter, the rechargeable lithium battery of some example embodiments is described in detail.

### N/P Ratio

The hybrid battery may be designed to have an N/P ratio of less than about 1, about 0.01 to about 0.99, or about 0.75 to about 0.9.

As described above, within the above range, lithium ions derived from a lithium salt of the electrolyte solution are deposited in a form of lithium metal on the upper surface of the negative electrode active material layer, so that the battery can be charged beyond the capacity limit of the negative electrode active material.

On the other hand, when the N/P ratio is greater than or equal to about 1, lithium ions derived from the lithium salt of the electrolyte solution cannot be deposited in the form of lithium metal on the upper surface of the negative electrode active material layer, and the hybrid nature of the battery may be lost.

Herein, the N/P ratio may be a ratio of the discharge capacity per unit area of the negative electrode to the discharge capacity per unit area of the positive electrode, and the N/P ratio may be a value when charged at a range of about 2.0 V to about 5.0 V for a rechargeable lithium battery.

The upper limit charge voltage of a generally known rechargeable lithium battery is in a range of about 4.25 V to about 4.30 V, while the upper limit charge voltage of the rechargeable lithium battery may be in a range of about 4.5 V to about 5.0 V.

### Lithium Metal Layer

The negative electrode may further include a lithium metal layer on the surface of the negative electrode active material layer.

When the rechargeable lithium battery is operated, lithium ions derived from the lithium salt in the electrolyte may be deposited in the form of lithium metal on the upper surface of the negative electrode active material layer. Herein, the electrolyte may include a lithium salt and a non-aqueous organic solvent.

### Amorphous Carbon

The amorphous carbon includes hard carbon, and the hard carbon may have a structure that is randomly oriented and that includes micropores.

Accordingly, lithium ions derived from the lithium salt in the electrolyte may be deposited in the form of lithium metal in the micropores of the hard carbon, among the upper surface of the negative electrode active material layer.

The hard carbon may have a BET surface area in a range of about 2.0 m²g⁻¹ to about 10.0 m²g⁻¹. In the above range, lithium metal can be readily deposited in the micropores of the hard carbon.

### Negative Electrode Active Material

The negative electrode active material may include graphite, a type of crystalline carbon.

### Boundary of Negative Electrode Active Material Layer

The boundary between the lower and upper portions of the negative electrode active material layer may be disposed within a range of about 30 thickness % to about 70 thickness %, and about 40 thickness % to about 60 thickness %, based on a total 100 thickness % of the negative electrode active material.

The negative electrode active material layer may have a multilayer structure in which the amounts of the amorphous carbon and of the negative electrode active material change intermittently at the boundary between the lower and upper portions of the negative electrode active material layer; or may have a single layer structure in which the amounts of the amorphous carbon and of the negative electrode active material change continuously, e.g., substantially continuously, at the boundary between the lower and upper portions of the negative electrode active material layer.

Based on 100 wt % of the upper portion of the negative electrode active material layer, the amount of the amorphous carbon may be greater than or equal to about 50 wt %.

Based on 100 wt % of the lower portion of the negative electrode active material layer, the amount of the negative electrode active material may be greater than or equal to about 50 wt %.

In the first half including the upper and lower portions of the negative electrode active material layer, a weight ratio of the amorphous carbon and the negative electrode active material may be in a range of about 1:9 to about 9:1, about 2:8 to about 8:2, about 3:7 to about 7:3, or about 4:6 to about 6:4.

### Positive Electrode Active Material

The positive electrode active material may be or include, for example, at least one of a lithium nickel-based oxide represented by Chemical Formula 11, a lithium cobalt-based oxide represented by Chemical Formula 12, a lithium iron phosphate-based compound represented by Chemical Formula 13, a cobalt-free lithium nickel-manganese-based oxide represented by Chemical Formula 14, or a combination thereof.

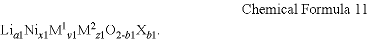

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² each independently is or includes one or more of Al, B, Ba, Ca, Ce, Co, Cr, Cu, Fe, Mg, Mn, Mo, Nb, Si, Sn, Sr, Ti, V, W, and Zr, and X is or includes one or more of F, P, and S.

In Chemical Formula 11, 0.6≤x1≤1, 0≤y1≤0.4, and 0≤z1≤0.4, or 0.8≤x1≤1, 0≤y1≤0.2, and 0≤z1≤0.2.

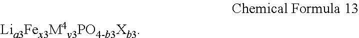

In Chemical Formula 13, 0.9≤a3≤1.8, 0.6≤x3≤1, 0≤y3≤0.4, and 0≤b3≤0.1, M⁴ is or includes one or more of Al, B, Ba, Ca, Ce, Co, Cr, Cu, Mg, Mn, Mo, Ni, Se, Si, Sn, Sr, Ti, V, W, Y, Zn, and Zr, and X is or includes one or more of F, P, and S.

The positive electrode active material may be composed solely of a lithium iron phosphate-based compound, or may include a mixture of a lithium iron phosphate-based compound and at least one of a composite oxide of lithium and a metal such as or including at least one of cobalt, manganese, nickel, and a combination thereof.

In the distribution of the positive electrode active material, the mixture of the lithium iron phosphate-based compound and at least one of a composite oxide of lithium and a metal such as or including at least one of cobalt, manganese, nickel, and a combination thereof, may be distributed on the lower portion of the positive electrode active material layer. At this time, only a lithium iron phosphate-based compound may be distributed on the upper portion of the positive electrode active material layer.

The composite oxide of lithium and a metal such as or including at least one of cobalt, manganese, nickel, and a combination thereof may have a nickel content that is greater than or equal to about 80 mol % based on 100 mol % of the metal excluding lithium.

The composite oxide of lithium and a metal such as or including at least one of cobalt, manganese, nickel, and a combination thereof may be or include a compound represented by Chemical Formula 11, and the lithium iron phosphate-based compound may be or include a compound represented by Chemical Formula 13.

### Positive Electrode

The positive electrode for a rechargeable lithium battery may include a current collector, and a positive electrode active material layer on the current collector. The positive electrode active material layer may include a positive electrode active material, and may further include a binder and/or a conductive material.

For example, the positive electrode may further include an additive that can constitute a sacrificial positive electrode.

An amount of the positive electrode active material may be in a range of about 90 wt % to about 99.5 wt % based on 100 wt % of the positive electrode active material layer, and each amount of the binder and the conductive material may be in a range of about 0.5 wt % to about 5 wt % based on 100 wt % of the positive electrode active material layer.

The binder improves binding properties of positive electrode active material particles with one another and with a current collector. Examples of the binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

The conductive material is included to provide electrode conductivity, and any electrically conductive material may be used as a conductive material unless the electrically conductive material causes an adverse chemical change in the battery. Examples of the conductive material may include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

### Negative Electrode

A negative electrode for a rechargeable lithium battery includes a current collector, and a negative electrode active material layer on the current collector. The negative electrode active material layer includes a negative electrode active material, and may further include a binder and/or a conductive material. The binder may be or include a binder of the aforementioned example embodiment.

For example, the negative electrode active material layer may include about 90 wt % to about 99 wt % of the negative electrode active material, about 0.5 wt % to about 5 wt % of the binder, and about 0.5 wt % to about 5 wt % of the conductive material.

The binder adheres the negative electrode active material particles to each other, and adheres the negative electrode active material to the current collector. The binder may be or include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be or include at least one of Na, K, or Li.

The dry binder may be or include a polymer material capable of becoming fiber, and may be or include, for example, at least one of polytetrafluoroethylene, polyvinylidene fluoride, a polyvinylidene fluoride-hexafluoropropylene copolymer, polyethylene oxide, or a combination thereof.

The conductive material is included to provide electrode conductivity, and any electrically conductive material may be used as a conductive material unless the electrically conductive material causes an adverse chemical change in the battery. Examples of the conductive material include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

The negative electrode current collector may include at least one of a copper foil, a nickel foil, a stainless steel foil, a titanium foil, a nickel foam, a copper foam, a polymer substrate coated with a conductive metal, and a combination thereof.

### Electrolyte Solution

An electrolyte solution for a rechargeable lithium battery includes a non-aqueous organic solvent and a lithium salt.

The non-aqueous organic solvent constitutes a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether group, and the like); amides such as dimethylformamide; dioxolanes such as 1,3-dioxolane, 1,4-dioxolane, and the like; sulfolanes, and the like.

The non-aqueous organic solvent may be used alone, or in a mixture of two or more types of solvents.

In addition, when using a carbonate-based solvent, a cyclic carbonate and a chain carbonate may be mixed, and the cyclic carbonate and the chain carbonate may be mixed in a volume ratio in a range of about 1:1 to about 1:9.

The electrolyte solution may further include at least one of vinylethyl carbonate, vinylene carbonate, fluoroethylene carbonate, difluoro ethylenecarbonate, chloroethylene carbonate, dichloroethylene carbonate, bromoethylene carbonate, dibromoethylene carbonate, nitroethylene carbonate, cyanoethylene carbonate, or a combination thereof as an additive.

The lithium salt dissolved in the organic solvent supplies lithium ions in a battery, enables an operation of a rechargeable lithium battery, and improves transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LoPO₂F₂, LiCl, Lil, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethane sulfonate, lithium difluorobis(oxalato)phosphate (LiDFOB), and lithium bis(oxalato) borate (LiBOB).

### Separator

Depending on the type of rechargeable lithium battery, a separator may exist between the positive and negative electrodes. Such a separator may include at least one of polyethylene, polypropylene, polyvinylidene fluoride, or a multilayer film of two or more layers thereof, and a mixed multilayer film such as a polyethylene/polypropylene two-layer separator, a three-layer separator, a polyethylene/polypropylene/polyethylene polypropylene/polyethylene/polypropylene three-layer separator, and the like.

The separator may include a porous substrate and a coating layer including an organic material, an inorganic material, or a combination thereof on one surface, or on both surfaces, of the porous substrate.

The porous substrate may be or include a polymer film formed of or including any one polymer such as or including at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked together.

### Rechargeable Lithium Battery

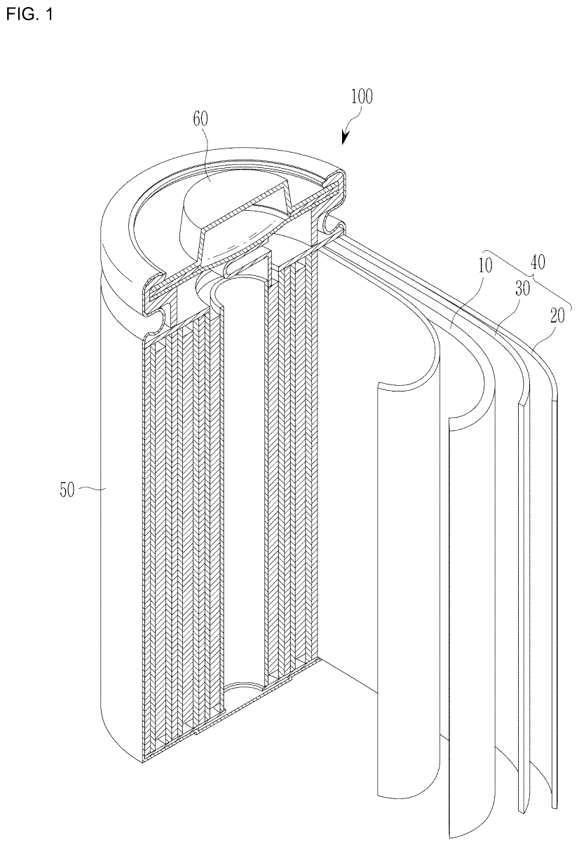

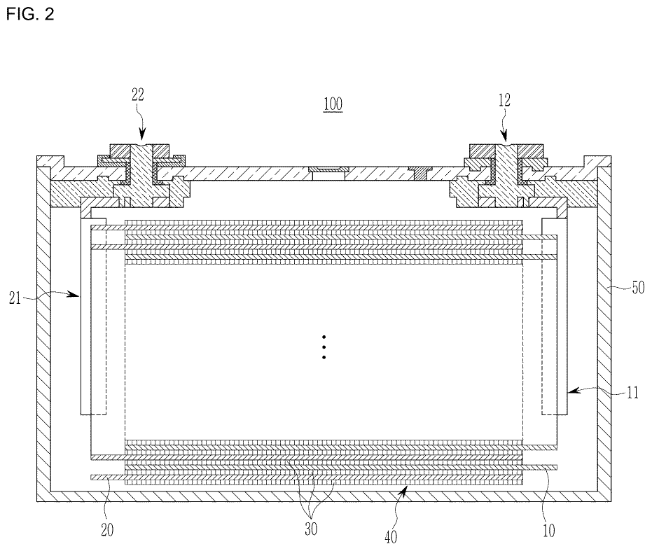

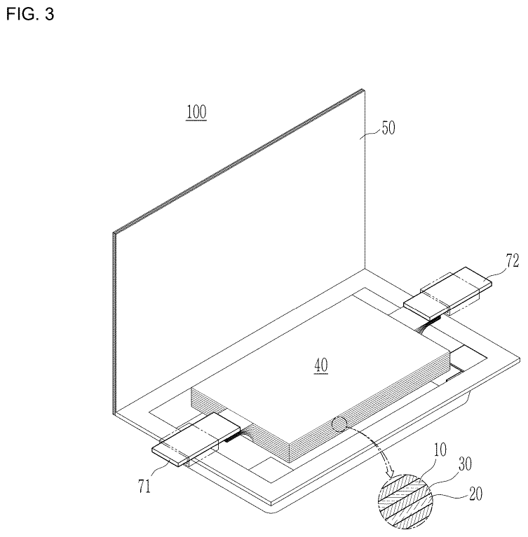

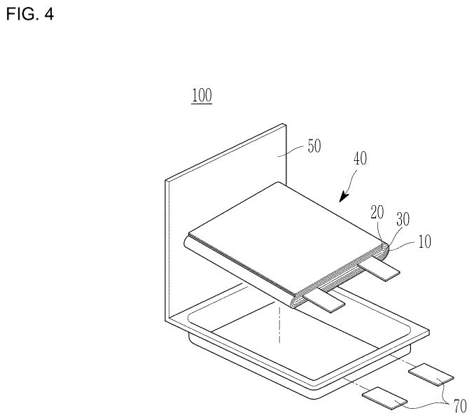

The rechargeable lithium battery may be classified into cylindrical, prismatic, pouch, or coin-type batteries, and the like depending on the shape thereof. FIGS. 1 to 4 are schematic views showing the rechargeable lithium battery according to some example embodiments, where FIG. 1 is a cylindrical battery, FIG. 2 is a prismatic battery, and FIGS. 3 and 4 are a pouch-shaped battery. Referring to FIGS. 1 to 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 1. In FIG. 2, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIGS. 3 and 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electrical path for inducing the current formed in the electrode assembly 40 to the outside of the battery 100.

The rechargeable lithium battery according to some example embodiments may be applicable to, e.g., automobiles, mobile phones, and/or various types of electrical devices, but the present disclosure is not limited thereto.

Examples and comparative examples of the present disclosure are described below. However, the following examples are only examples of the present disclosure, and the present disclosure is not limited to the following examples.

### Example 1

### (1) Manufacturing of Negative Electrode

A 10 μm-thick copper foil was prepared as a negative electrode current collector.

Artificial graphite (D50:15.5, μm BET: 0.9 m²g⁻¹) was used as a negative electrode active material, and the negative electrode active material: styrene-butadiene rubber binder: carboxylmethyl cellulose were mixed in a weight ratio of 97:1:2, and then dispersed in distilled water, preparing a lower slurry.

The lower slurry was coated on the copper foil, and then dried and compressed to form a lower portion (a thickness: 45 μm) of a negative electrode active material layer.

On the other hand, hard carbon (D50: 8.0 μm, BET: 3.6 m²g⁻¹) was used as amorphous carbon, and the hard carbon was mixed with a styrene-butadiene rubber binder and carboxylmethyl cellulose in a weight ratio of 97:1:2 (=hard carbon: styrene-butadiene rubber binder: carboxylmethyl cellulose), and then dispersed in distilled water, preparing an upper slurry.

On the lower portion of the negative electrode active material layer, the upper slurry was coated, and then dried and compressed, forming an upper portion (a thickness: 45 μm) of the negative electrode active material layer.

When a solid content in the lower slurry was called to be a first solid content, and a solid content in the upper slurry was called to be a second solid content, the first solid and the second solid had a weight ratio of 50:50. Accordingly, based on a total 100 thickness % of the positive electrode active material layer, each lower and upper thickness of the positive electrode active material layer was set to 50 thickness %.

### (2) Manufacturing of Rechargeable Lithium Battery Cell

As a positive electrode current collector, a 10 μm-thick aluminum foil was prepared.

LiNi_{0.88}Co_{0.08}Al_{0.04}O₂ as a positive electrode active material, carbon black as a conductive material, and polyvinylidene fluoride (PVDF) as a binder were mixed in a weight ratio of 97:1.5:1.5, and then dispersed in N-methyl-2-pyrrolidone, preparing a positive electrode slurry.

The positive electrode slurry was coated on the aluminum foil, and then dried and compressed, forming a positive electrode active material layer (a thickness: 100 μm).

An electrolyte solution was prepared by mixing 1.5 M lithium salt (LiPF₆) with a carbonate solvent including ethylene carbonate (EC): ethyl methyl carbonate (EMC): dimethyl carbonate (DMC) mixed in a volume ratio of 20:40:40.

A polyethylene separator was assembled with the manufactured positive and negative electrodes to manufacture an electrode assembly, which was inserted into a case, and the electrolyte solution was injected thereinto, manufacturing a 2023 coin-type rechargeable lithium battery cell.

### Example 2

A negative electrode and a rechargeable lithium battery cell of Example 2 were manufactured in the same manner as in Example 1, with a difference that the weight ratio of hard carbon:styrene-butadiene rubber binder:carboxylmethyl cellulose was changed to 97.5:1:1.5 in preparing the upper negative electrode slurry.

### Example 3

A negative electrode and a rechargeable lithium battery cell of Example 3 were manufactured in the same manner as in Example 1, with a difference that the weight ratio of hard carbon:styrene-butadiene rubber binder:carboxylmethyl cellulose was changed to 98:0.5:1.5 in preparing the upper negative electrode slurry.

### Example 4

The first solid and the second solid had a weight ratio of 30:70. Accordingly, based on based on a total 100 thickness % of the negative electrode active material layer, the lower and upper portions of the negative electrode active material layer were controlled to have each thickness of 30 thickness % and 70 thickness %.

Except for the above, a negative electrode and a rechargeable lithium battery cell of Example 4 were manufactured in the same manner as in Example 3.

### Example 5

The first solid and the second solid had a weight ratio of 40:60. Accordingly, based on a total 100 thickness % of the negative electrode active material layer, the lower and upper portions of the negative electrode active material layer were controlled to have each thickness of 40 thickness % and 60 thickness %.

Except for the above, a negative electrode and a rechargeable lithium battery cell of Example 5 were manufactured in the same manner as in Example 3.

### Example 6

The first solid and the second solid had a weight ratio of 60:40. Accordingly, based on a total 100 thickness % of the negative electrode active material layer, the lower and upper portions of the negative electrode active material layer were controlled to have each thickness of 60 thickness % and 40 thickness %.

Except for the above, a negative electrode and a rechargeable lithium battery cell of Example 6 were manufactured in the same manner as in Example 3.

### Example 7

The first solid and the second solid had a weight ratio of 70:30. Accordingly, based on a total 100 thickness % of the negative electrode active material layer, the lower and upper portions of the negative electrode active material layer were controlled to have each thickness of 70 thickness % and 30 thickness %.

Except for the above, a negative electrode and a rechargeable lithium battery cell of Example 7 were manufactured in the same manner as in Example 3.

### Comparative Example 1 (Ref.)

A positive electrode and a rechargeable lithium battery cell of Comparative Example 1 were manufactured in the same manner as in Example 3, with a difference that the lower slurry alone was used to form a negative electrode active material layer with a thickness of 90 μm as a single layer.

### Comparative Example 2

A positive electrode and a rechargeable lithium battery cell of Comparative Example 2 were manufactured in the same manner as in Example 3, with a difference that the upper slurry alone was used to form a hard carbon layer with a thickness of 90 μm as a single layer.

### Comparative Example 3

A positive electrode and a rechargeable lithium battery cell of Comparative Example 3 were manufactured in the same manner as in Example 3, with a difference that the N/P ratio was changed to 1 by forming the positive electrode active material layer to have a thickness of 75 μm.

### Comparative Example 4

A positive electrode and a rechargeable lithium battery cell of Comparative Example 4 were manufactured in the same manner as in Example 3, with a difference that the N/P ratio was changed to 1.25 by forming the positive electrode active material layer to have a thickness of 60 μm.

In Tables 1 and 2 below, each component content based on 100 parts by weight of a lower portion, each component content based on 100 parts by weight of an upper portion, and a thickness ratio of the lower and upper portions, are summarized.

TABLE 1

| | | Example 1 | Example 2 | Example 3 | Example 4 | Example 5 | Example 6 | Example 7 |
|---|---|---|---|---|---|---|---|---|
| Lower portion | negative electrode | 97 | 97 | 97 | 97 | 97 | 97 | 97 |
| (100 parts by | active material | | | | | | | |
| weight) | conductive material | 1 | 1 | 1 | 1 | 1 | 1 | 1 |
| | binder | 2 | 2 | 2 | 2 | 2 | 2 | 2 |
| Upper portion | hard carbon | 97 | 97.5 | 98 | 97 | 97 | 97 | 97 |
| (100 parts by | conductive material | 1 | 1 | 0.5 | 1 | 1 | 1 | 1 |
| weight) | binder | 2 | 1.5 | 1.5 | 2 | 2 | 2 | 2 |

| | | | | | | | |
|---|---|---|---|---|---|---|---|
| Thickness ratio of | 50:50 | 50:50 | 50:50 | 30:70 | 40:60 | 60:40 | 70:30 |
| lower portion:upper portion | | | | | | | |
| N/P Ratio | 0.75 | 0.75 | 0.75 | 0.75 | 0.75 | 0.75 | 0.75 |

TABLE 2

| | | Comparative | Comparative | Comparative | Comparative |
|---|---|---|---|---|---|
| | | Example 1 | Example 2 | Example 3 | Example 4 |
| Lower portion | negative electrode active | 97 | — | 97 | 97 |
| (100 parts | material | | | | |
| by weight) | conductive material | 1 | — | 1 | 1 |
| | binder | 2 | — | 2 | 2 |
| Upper portion | hard carbon | — | 97 | 97 | 97 |
| (100 parts | conductive material | — | 1 | 1 | 1 |
| by weight) | binder | — | 2 | 2 | 2 |

| | | | | |
|---|---|---|---|---|
| Thickness ratio of lower portion:upper portion | 100:0 | 0:100 | 50:50 | 50:50 |
| N/P Ratio | 0.75 | 0.75 | 1.0 | 1.25 |

### Evaluation Example 1: Electrochemical Characteristics of Rechargeable Lithium Battery Cells

The rechargeable lithium battery cells of Examples 1 to 7 and Comparative Examples 1 and 2 were measured with respect to formation capacity and charge rate capability, as follows. The results are provided in Tables 3 and 4 below.

(1) Formation Capacity: The cells were 2 cycles charged and discharged within a voltage range of 2.0 V to 3.7 V at 0.1 C (@ 25° C.).

In addition, after the formation capacity, 0.033 C charge capacity was also separately measured.

(2) Charge Rate Capability: The cells were measured with respect to a charge rate from 0.2 C to 2 C within a voltage range of 2.0 V to 5.0 V (@ 25° C.).

TABLE 3

| Experiment | | Example 1 | Example 2 | Example 3 | Example 4 | Example 5 | Example 6 | Example 7 |
|---|---|---|---|---|---|---|---|---|
| Formation | 1st Discharge | 5.75 mAh | 5.74 mAh | 5.72 mAh | 5.54 mAh | 5.63 mAh | 5.89 mAh | 6.01 mAh |
| | 0.1 C Capa. | | | | | | | |
| 0.033 C | 2.0 V to 5.0 V | 7.42 mAh | 7.40 mAh | 7.33 mAh | 7.51 mAh | 7.44 mAh | 7.01 mAh | 6.64 mAh |
| Charge | Discharge Capa. | | | | | | | |
| Efficiency | Eff. (%) | 73.1 | 73.3 | 73.2 | 79.1 | 75.2 | 71.0 | 67.2 |
| C-rate | 0.2 C | 98.2 | 98.1 | 98.0 | 98.0 | 97.6 | 97.4 | 98.1 |
| (%) | 0.33 C | 95.4 | 95.3 | 95.2 | 96.1 | 95.4 | 94.7 | 94.1 |
| | 0.5 C | 88.2 | 88.1 | 88.0 | 90.1 | 88.2 | 86.3 | 84.4 |
| | 0.75 C | 76.4 | 76.3 | 76.2 | 78.0 | 76.4 | 74.8 | 73.2 |
| | 1 C | 70.1 | 70.0 | 69.9 | 72.5 | 70.1 | 67.6 | 65.2 |
| | 1.5 C | 52.2 | 52.1 | 52.0 | 55.6 | 52.2 | 48.8 | 45.3 |
| | 2 C | 35.1 | 35.0 | 34.9 | 40.0 | 35.1 | 30.2 | 25.3 |

TABLE 4

| | | | Comparative | Comparative | Comparative | Comparative |
|---|---|---|---|---|---|---|
| Experiment | | | Example 1 | Example 2 | Example 3 | Example 4 |
| Formation | 1st Discharge | | 6.15 mAh | 5.32 mAh | 6.14 mAh | 6.16 mAh |
| | 0.1 C Capa. | | | | | |
| 0.033 C | 2.0 V to 5.0 V | | 6.19 mAh | 7.66 mAh | 7.55 mAh | 7.65 mAh |
| Charge | Discharge Capa. | | | | | |
| Efficiency | Eff. (%) | | 84.4 | 62.5 | 85.1 | 86.2 |
| C-rate | 0.2 | C | 98.2 | 98.2 | 98.0 | 97.5 |
| (%) | 0.33 | C | 92.1 | 98.04 | 90.2 | 88.1 |
| | 0.5 | C | 78.6 | 95.88 | 75.3 | 74.2 |
| | 0.75 | C | 68.5 | 82.72 | 62.2 | 60.1 |
| | 1 | C | 57.8 | 79.94 | 51.3 | 49.3 |
| | 1.5 | C | 35.0 | 65.96 | 30.0 | 25.5 |
| | 2 | C | 10.7 | 54.62 | 6.2 | 4.0 |

Comparative Example 1, which was a rechargeable lithium battery cell including a negative electrode active material layer as a single layer, compared to Examples 1 to 7, exhibited low capacity, when charged to a high voltage after the formation.

Comparative Example 2, which was a rechargeable lithium battery cell including a hard carbon layer as a single layer, compared to Examples 1 to 7, exhibited low formation capacity and low efficiency.

Comparative Examples 3 and 4, which were rechargeable lithium battery cells having each N/P ratio of 1 and 1.25, exhibited inferior energy density due to the thick negative electrode layer to Example 3 having the same structure as the comparative examples except for the N/P ratio, and was also disadvantageous in terms of price, and in addition, the thick negative electrode layer was disadvantageous for lithium ion movement, thereby deteriorating rapid charge performance. However, because there was no deposition on the active material as in Example 3, as the amount of precipitation was reduced, cycle-life was expected to be superior.

On the contrary, the rechargeable lithium battery cells according to some example embodiments, which were represented by Examples 1 to 7, exhibited high capacity during the charge to high voltages after the formation.

Furthermore, the rechargeable lithium battery cells according to some example embodiments, which were represented by Examples 1 to 7, were hybrid battery cells designed to have an N/P ratio of less than 1, and thus exhibited desired or improved capacity characteristics, and high-rate charging of the hybrid battery cells was possible due to the amorphous carbon.

While this disclosure has been described in connection with what is presently considered to be practical example embodiments, it is to be understood that the disclosure is not limited to the disclosed embodiments. On the contrary, the disclosure is intended to cover various modifications and equivalent arrangements included within the spirit and scope of the appended claims.

Description of Symbols:

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. A rechargeable lithium battery comprising:
a positive electrode;
a negative electrode; and
an electrolyte between the positive electrode and the negative electrode;
wherein the negative electrode comprises:
a negative electrode current collector; and
a negative electrode active material layer on the negative electrode current collector;
the negative electrode active material layer comprises:
amorphous carbon; and
a negative electrode active material;
from an upper portion farther from the negative electrode collector to a lower portion closer to the negative electrode collector:
an amount of the negative electrode active material increases and an amount of the amorphous carbon decreases; and
the rechargeable lithium battery has a ratio of a discharge capacity per unit area of the negative electrode to the discharge capacity per unit area of the positive electrode that is less than about 1.

2. The rechargeable lithium battery as claimed in claim 1, wherein the rechargeable lithium battery has a ratio of a discharge capacity per unit area of the negative electrode to the discharge capacity per unit area of the positive electrode in a range of about 0.01 to about 0.99.

3. The rechargeable lithium battery as claimed in claim 1, wherein the negative electrode further comprises:
a lithium metal layer on a surface of the negative electrode active material layer.

4. The rechargeable lithium battery as claimed in claim 3, wherein:
the electrolyte comprises a lithium salt and a non-aqueous organic solvent, and
when driving the rechargeable lithium battery, lithium ions derived from the lithium salt are deposited in a form of lithium metal on an upper surface of the negative electrode active material layer.

5. The rechargeable lithium battery as claimed in claim 1, wherein an upper limit charge voltage of the rechargeable lithium battery is in a range of about 4.5 V to about 5.0 V.

6. The rechargeable lithium battery as claimed in claim 1, wherein:
the amorphous carbon comprises hard carbon, and
the hard carbon has a structure that is randomly oriented and that comprises micropores.

7. The rechargeable lithium battery as claimed in claim 1, wherein the negative electrode active material comprises graphite.

8. The rechargeable lithium battery as claimed in claim 1, wherein the boundary between the lower and upper portions of the negative electrode active material layer is disposed within a range of about 30% to about 70% based on a total 100 thickness % of the negative electrode active material.

9. The rechargeable lithium battery as claimed in claim 8, wherein the negative electrode active material layer comprises one of:
a multilayer structure in which amounts of the amorphous carbon and of the negative electrode active material are intermittently changed at the boundary between the lower and upper portions of the negative electrode active material layer; and
a single-layer structure in which the amounts of the amorphous carbon and of the negative electrode active material substantially continuously change at the boundary between the lower and upper portions of the negative electrode active material layer.

10. The rechargeable lithium battery as claimed in claim 1, wherein based on 100 wt % of the upper portion of the negative electrode active material layer:
the amount of the amorphous carbon is greater than or equal to about 50 wt %.

11. The rechargeable lithium battery as claimed in claim 1, wherein based on 100 wt % of the lower portion of the negative electrode active material layer:
the amount of the negative electrode active material carbon is greater than or equal to about 50 wt %.

12. The rechargeable lithium battery as claimed in claim 1, wherein in the first half comprising the upper and lower portions of the negative electrode active material layer:
a weight ratio of the amorphous carbon and the negative electrode active material is in a range of about 1:9 to about 9:1.
